(19) United States
(12) Patent Application Publication
(10) Pub. No.: US 2003/0200103 A1
(43) Pub. Date: Oct. 23, 2003

(54) Marketing management system

(76) Inventor: Chin-Chun Li, Kaohsiung (TW)

Correspondence Address: Ladas & Parry, 26 West 61 Street, New York, NY, 10023, US

(21) Appl. No.: 10/125,636

(22) Filed: Apr. 18, 2002

(51) Int. Cl. G06F 17/60

(52) U.S. Cl. 705/1

(57) ABSTRACT

The present invention relates to a marketing management system. The marketing management automatically produces a rank and an order of a member in a block of a database according to a joining time of the member. The member has a reward from a plurality of lower-ranking members. The marketing management system mainly comprises an input means, a database, and a cycle calculator. After the member joins the system, the member can buy products at a lower price and have a great reward calculated by the cycle calculator. The system further comprises a promotion calculator for promoting the member to a higher block in the database. The member can have various positions in the various blocks, and get the reward from the various blocks. According to the invention, the system has automatically integrated operation, and can be applied to the marketing management so as to solve problems in the marketing management.

### BACKGROUND OF THE INVENTION

1. Field of the Invention

The present invention relates to a computer system, more particularly, to a marketing management system, a marketing management method using the marketing management system and a computer-readable medium for recording computer-executable programs for executing the marketing management method.

2. Description of the Related Art

After a person joins a conventional direct selling company, the person must strive to invite other peoples to join the conventional direct selling company to be a low-ranking member of the person so as to share the rewards of the low-ranking member. However, the low-ranking is members are usually few. Therefore, after the people joins the conventional direct selling company, the people usually stay in a stagnant stage.

Conventional Internet companies and E-commence companies can not attract a customer easily, and must pay advertisement fees and marketing fees to attract the customer. Although, the customer enters the website, he/she does not necessarily buy products in the Internet company. Therefore, most of the Internet companies suffer from losses in business.

Therefore, it is desirable to provide a novel and creative system to overcome the above problems.

### SUMMARY OF THE INVENTION

One objective of the present invention is to provide a marketing management system. The marketing management automatically produces a rank and an order of a member in a block of a database according to a joining time of the member. The member has a reward from a plurality of lower-ranking members. The member can buy the product at a price lower than market price via the marketing management system. According to the invention, the member can get the benefit without the cost of the store, and the benefit of the great amount purchase. The marketing management system can be applied to the Internet, and the cost of advertisement can be save to dispense to the member. Because of the popularity of the World Wide Web, the member of the marketing management system will increase rapidly. The price of the product can be lowered and the reward of member will increase, and the living of a member can be promoted.

Another objective of the present invention is to provide a marketing management system. By the operation of the World Wide Web, people on the world can join the system of the invention to form a great customer group. The company, factory, website, E-commerce company on the world can cooperate with the marketing management system of the invention so as to lead member of the system to purchase product in the company. The company can save the cost of advertisement and marketing.

Still another objective of the present invention is to provide a marketing management system. The member of the system can be people, store, company and enterprise. Therefore, the marketing management system of the invention can be applied to the marketing management between Business to Customer (B2C) and the marketing management between Business to Business (B2B) so as to reduce the cost of marketing.

Still another objective of the present invention is to provide a method utilizing the marketing management system in order to obtain the above objects by executing the method in the above systems.

Still another objective of the present invention is to provide a computer-readable medium that records computer-executable programs for executing a marketing management system so that the marketing management system can be practiced.

Still other advantages of the present invention will become readily apparent by those skilled in the art from the following detailed description that is described by way of illustration of the drawings. As the invention will be realized, the invention is capable of other and different embodiments, and its several details are capable of modifications in various respects, without departing from the invention. Accordingly, the drawings and description are to be regarded as illustrative in nature and not as restrictive.

### BRIEF DESCRIPTION OF THE DRAWINGS

FIG. 1 is a block diagram illustrating a marketing management system according to the present invention.

FIG. 2 is a tree structure in the first block of the database according to the present invention.

FIG. 3 is a tree structure in the second block of the database according to the present invention.

FIG. 4 is a flow chart illustrating a method according to the present invention.

### DETAILED DESCRIPTION OF THE INVENTION

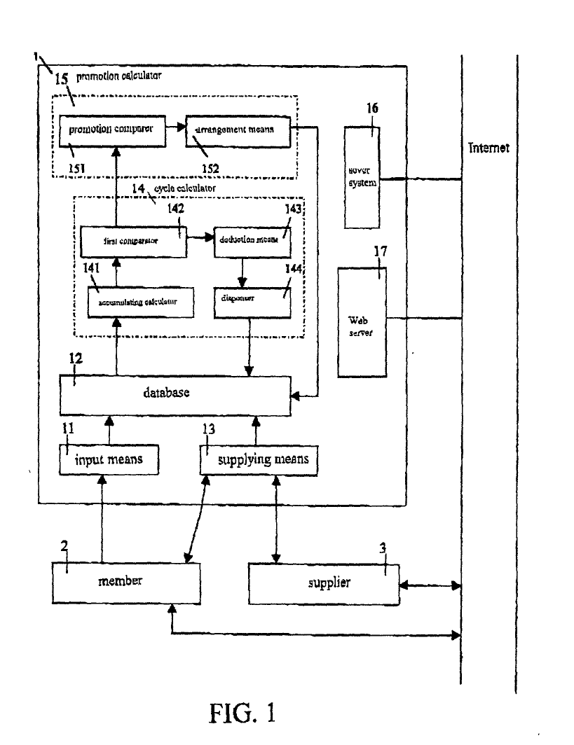

Referring to FIG. 1, a marketing management system 1 comprises; an input means 11, a database 12, a supplying means 13 and a cycle calculator 14. The input means 11 receives data from a member and outputs a joining time of the member to the database 12. The database has at least one block. Each block has a plurality of nodes for storing the data of member. Each node in the block has an order and a rank which represent the joining time of the member. The later the member joins the block, and the lower the rank and order of the member are in the node of the database.

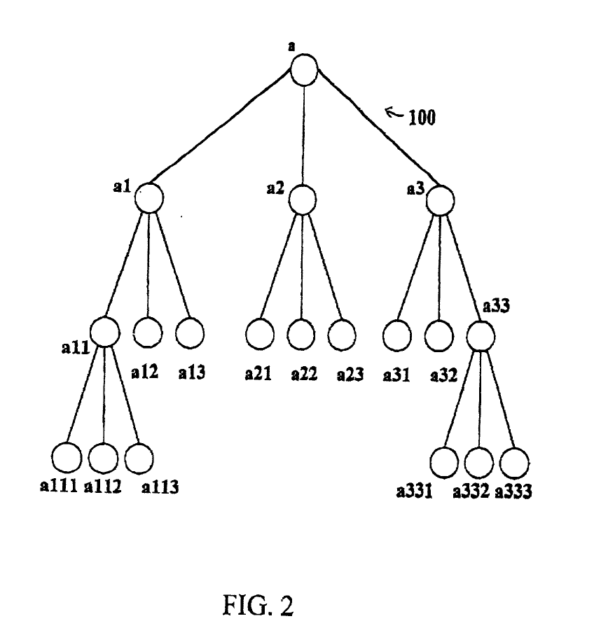

The database 12 has at least one block. Each block has at least one tree structure. Referring to FIG. 2, a tree structure 100 has a plurality of node (a) to (a333). Each node has three branches. Each branch links to a node of the next rank. The node (a) of the first rank links to three nodes (a1), (a2) and (a3) through the branches. The node (a1) of the second rank links to three nodes (a11), (a12) and (a13). Therefore, the node has a different rank and order.

The marketing management system 1 receivers data from a member. After admitting the member to join the system, the marketing management system 1 determines an order and a rank of a node for the member. The later the member joins the system, and the lower the rank and order of the member is in tree. For example, the joining time of the node (a12) of the lower rank is later than the nodes (a1), (a2) and (a3) of the upper rank, and is later than the node (a11) with the same rank but higher order.

Compared with the conventional direct selling company, the system of the invention automatically produces a tree structure 100 according to the joining time of member. A member of the system does not need to strive to invite other people to be a lower-ranking member. Therefore, after a member joins the system, the system automatically arranges another member which has the joining time later than the member to be a member with a lower rank and order. The problem with the conventional direct selling company can be solved by the system of the invention.

The supplying means 13 receives products from the supplier 3, and the member can buy the products. Because the members of the system 1 are great, the supplier 3 must be able to provide the system 1 with the product at price lower than a market price and close to the lowest cost. Therefore, the member of the system 1 can buy the product at a lower price. Furthermore, the member of the system is a distributor, and can sell the product to a person who is not a member.

The member can have a reward when the member buys the product. The cycle calculator 14 calculates the reward of the member in the block according to the order and rank of the member. The reward comprises dividends at different percentages from a plurality of members having a lower rank than the member.

The cycle calculator 14 comprises: an accumulating calculator 141, a first comparator 142, a deduction means 143 and a dispenser 144. The accumulating calculator 141 calculates the accumulated reward of the member in the block in a fixed period (eg., a week). The reward comprises a selling reward and a purchase profit reward from a plurality of lower-ranking member.

After the accumulating calculator 141 calculates the accumulated reward of the member in the block, the first comparator 142 compares the reward of the member and a first number limit of the block. If the reward of the member is larger than the first number limit, the deduction means 143 deducts a deduction number of the block from the reward of the member The dispenser 144 dispenses the deduction number to a plurality of higher-ranking members at different percentages.

The member can buy a product at a lower price, and the higher-ranking members have a reward. The member can buy the product at the price which is the cost plus half of the difference between the market price and the cost. For example, the market price of the product is 10000 dollars, the cost of the product is 6500 dollars. The supplier sells the product to the system at the cost price 7000 dollars, and the difference between the market price and the cost price is 3000 dollars. According to the system of the invention, the member can buy the product at the price 8500 dollars (7000+(3000/2)), but in fact the member buy the product at the price 9000 dollars. The 500 dollars (9000−8500) is the purchase profit reward of the member, and is accumulated to the reward of the member. The 40% of the 1500 dollars is dispensed to ten higher-ranking members. Therefore, each of ten higher-ranking members has purchase profit reward 60 dollars accumulated to the reward of each of ten members. The 60% of the 1500 dollars is the administrative fee of the system.

The member of the system can be a distributor, and introduce a person who is not member to buy the products. The person who is not member also can buy the product at lower price. Given in the above example, the market price of the product is 10000 dollars and the cost price is 7000 dollars. The person who is not member can buy the product at the price 9000 dollars. Therefore, the member has an introduction reward 500 dollars (9000−8500) accumulated to the reward of the member.

The accumulating calculator 141 calculates the above reward per week. The first comparator 142 compares the reward of the member and a first number limit of the first block, for example the first number limit of the first block is 2500 dollars. When the reward of the member is larger is than the first number limit, the reward can be dispensed to the member. If the reward of the member is smaller than the first number limit, the reward can be accumulated continuously to exceed the first number limit. The reward comprises a prize and a bonus. The bonus is the difference between the reward and the deduction number of the first block.

For example, the reward of the member is 10000 dollars, and the member can get a prize and a bonus. The bonus is 6140 dollars (10000−1680 (the deduction number of the first block)−180 (postage)−2000 (service fee of the system, 20% of the reward 10000). Therefore, the member has a prize and a bonus of 6140 dollars.

The dispenser 144 dispenses the deduction number of the first block 1680 dollars to a plurality of higher-ranking member at different percentages. In the above example, the deduction number of the first block 1680 dollars is dispensed to three higher-ranking members. Referring to FIG. 2, if the member is the node (a111), the deduction number is dispensed the higher-ranking members (a11), (a1) and (a). According to the system of the invention, the higher-ranking member (a11) has the reward 550 dollars, the higher-ranking member (a1) has the reward 350 dollars, the higher-ranking member (a) has the reward 200 dollars. The above reward of the higher-ranking members (a11), (a1) and (a) are accumulated to the reward of a next period (eg., next week).

In other words, after the accumulating calculator 141 calculates the reward of each member, if the reward of all members is larger than the first number limit (2500) in this week, the member (a) has the reward in the next week. In the next week the reward of the member (a) comprises: the reward 1650 (550×3) of three nodes (a1, a2 and a3), the reward 3150 (350×9) of nine nodes (a11 to a33) and the reward 5400 (200×27) of the twenty-seven nodes (a111 to a333). Therefore, in the next week the member has the reward at least 10200, as shown in Table 1.

TABLE 1

| | Number of | | |
|---|---|---|---|
| | members | Reward(dollars) | Sum(dollars) |
| The first lower rank | 3 | 550 | 1650 |
| The second lower rank | 9 | 350 | 3150 |
| The third lower rank | 27 | 200 | 5400 |
| Total | 39 | | 10200 |

The marketing management system 1 further comprises a promotion calculator 15. The promotion calculator 15 comprises: a promotion comparator 151 and an arrangement means 152. The promotion comparator 151 compares the reward with a promote number limit of the block. If the reward of the member in the block is larger than the promote number limit, the arrangement means 152 determine a rank and an order of a node in the next block of the database. The cycle calculator 14 calculates a reward of the member in the next block according to the rank and order of the node in the next block.

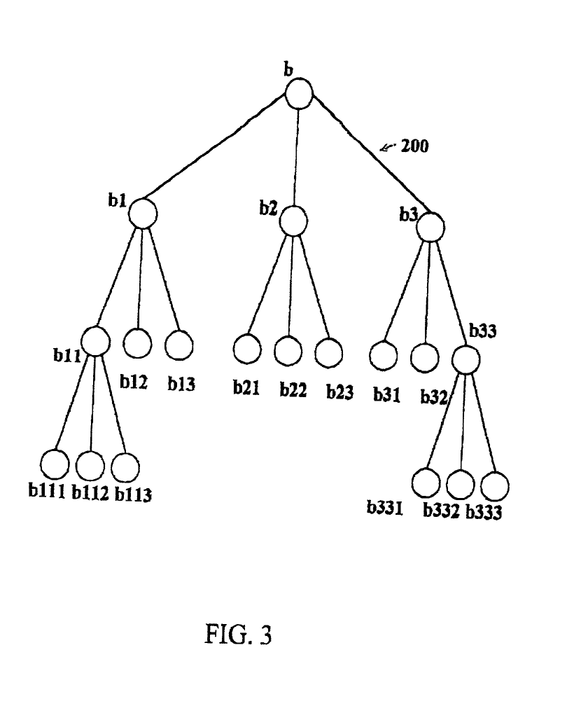

After the member joins the first block of the system, the member can has a considerable reward. For the purpose of the more reward of the member, the database 12 of the system 1 has a plurality of blocks with a tree structure. When the reward of the member in the first block is larger than the promotion number limit of the first block in a week, the member promotes automatically to a position in the second block with a tree structure 200, as shown in FIG. 3. The arrangement means 152 determines a rank and an order of the position in the second block of the database. The member has the reward from both the first block and the second block.

When the reward of the member in the first block is larger than the promotion number limit (for example, 6600) in a week, the system deducts the first deduction number and the second deduction number from the reward, and promote the member into a position of the second block. For example, the second deduction number is 3680 dollars and the service fee of the system is 1000 dollars. If the reward of the member (a333) in the first block is larger than the promotion number limit 6600 dollars in a week, the system deducts 6360 dollars (1680: the first deduction number, 3680: the second deduction number and 1000: the service fee) from the reward, and promote the member (a333) into the position (b) of the second block. Therefore, the reward of the member comprises the reward from the node (a333) of the fast block and the reward from the node (b) of the second block.

As illustrated in the calculation of the first block, the accumulating calculator 141 calculates the reward of each member in the second block per week. The first comparator 142 compares the reward of the member with a second number limit of the second block, for example the second number limit of the second block is 5000 dollars. When the reward of the member is larger than the second number limit 5000, the reward can be dispensed to the member. If the reward of the member is smaller than the second number limit 2500, the reward can be accumulated continuously until to exceed the second number limit. The reward comprises a prize and a bonus. The bonus is the difference of the reward and the deduction number of the second block.

For example, the reward of the member is 38000 dollars in a week, and the member can get a prize and a bonus. The bonus is 26540 dollars (38000−3680 (the deduction number of the second block)−180 (postage)−7600 (service fee of the system, 20% of the reward: 38000). Therefore, the member has a prize and a bonus 26540 dollars.

The dispenser 144 dispenses 3680 dollars to a plurality of higher-ranking member with higher rank than the member at different percentages. In the above example, the deduction number of the second block (3680 dollars) is dispensed to five higher-ranking members.

In other words, after the accumulating calculator 141 calculates the reward of each member, if the reward of all members is larger than the second number limit (5000) in this week, the member (b) has the reward in the next week. The reward of the member (b) comprises the reward from the lower-ranking members at five lower ranks, as shown in Table 2.

TABLE 2

| | Number of | | |
|---|---|---|---|
| | members | Reward(dollars) | Sum(dollars) |
| The first lower rank | 3 | 1200 | 3600 |
| The second lower rank | 9 | 500 | 4500 |
| The third lower rank | 27 | 300 | 8100 |
| The fourth lower rank | 81 | 200 | 16200 |
| The fifth lower rank | 243 | 100 | 24300 |
| Total | 363 | | 57600 |

The member can be promoted to the third, the fourth and even higher blocks utilizing the promotion calculator 15 of the invention. Therefore, the invention provides a novel, automatic and progressive marketing management system 1. The member of the system can buy the product at a lower price, and can get the great reward by the calculation of the cycle calculator 14 and the promotion calculator 15. The member can be placed at various nodes in the various blocks, and get the reward from the various blocks. The member is like a person who runs many companies at the same time in the country or the world. It is commendable that the customers (the lower members under the higher-ranking member) will loyally follow the higher-ranking member and buy the products in the system. Especially, the system 1 has automatically integrated operations, and can be utilized to the marketing management.

The marketing management system 1 further comprises a server system 16 and a Web server 17 so that the system 1 can be applied to the Internet. The server system 16 is provided to link the system 1 to the Internet. The Web server 17 is provided to link the terminals of members to the Internet. Therefore, any member in die Internet can use the system 1 of the invention.

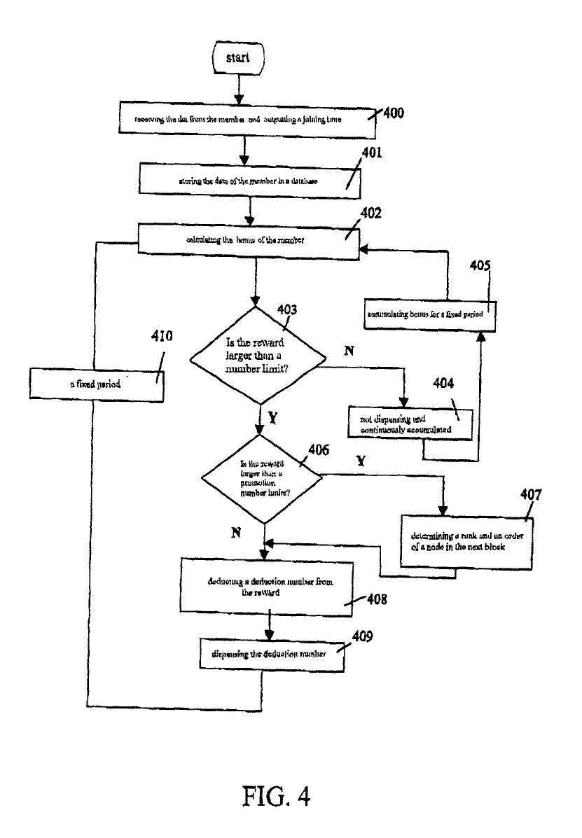

Referring to FIG. 4, the flow chart illustrates the method according to the present invention. In step 400, the data of a member is received, and a joining time of the member is output. In step 401, the data of the member is stored in a database, and an order and a rank of a node in a block of the database is determined according to the joining time of the member. The later the member joins the system, the lower the rank and order of the member are in the nodes of the database.

In step 402, the reward of the member in a block is calculated in a fixed period. In step 403, the reward of the member compares with a first number limit. If the reward of the member is not larger than the first number limit, the reward is not dispensed, as shown in step 404. In step 405, the reward is accumulated continuously in the next period.

If the reward of the member is larger than the first number limit, the reward is compared with a promotion number limit, as shown in step 406. If the reward of the member is larger than the promotion number limit, the member is promoted to the next block, and a rank and an order of a node of the member is determined, as shown in step 407. If the reward of the member is not larger than the promotion number limit, the reward is deducted by a deduction number, as shown in step 408. In step 409, the deduction number is dispensed. The deduction number is dispensed to a plurality of higher-ranking members at different percentages. The reward of the higher-ranking members is accumulated to the next period (eg., next week).

A fixed period is pass, as shown in step 410. The reward of the member is calculated again, as shown in step 402. The above steps are repeated. The method of the next block is the same as the above steps. The member can be promoted to a higher block.

For the purpose of applied the method to the Internet, relevant information of the system must be shown on the website, and the system 1 can receive the data of the member on the Internet. The member can join the system via the Internet.

Computer programs can implement the above method. The programs can be loaded into a computer or a programmable information processor to execute the function of the flow chart of FIG. 4. The programs can be stored in a computer-readable medium (for example, magnetic tape, magnetic disc, compact disc, hard disc and IC memory, etc) for future loading them into the computer. Therefore, the invention further discloses a computer-readable medium recording computer-executable programs for the method of the invention.

While an embodiment of the present invention has been illustrated and described, various modifications and improvements can be made by those skilled in the art. The embodiment of the present invention is therefore described in an illustrative but not restrictive sense. It is intended that the present invention is not limited to the particular forms as illustrated, and that all the modifications not departing from the spirit and scope of the present invention are within the scope as defined in the appended claims.

We claim:

1. An marketing management system, comprising:
an input means for receiving data from a member and outputting a joining time of the member;
a database, having at least one block, each block having a plurality of nodes for storing the data of members, each node having an order and a rank determined by the joining time of a member, and
a cycle calculator, for calculating a reward of the member in the block according to the order and the rank of the member.

2. The marketing management system as claimed in claim 1, wherein a plurality of nodes form a tree structure, a plurality of branches are produced from the node, the branch links to a node of the next rank so that the node has a different rank and order with the other nodes, and the later the joining time of the member is, and the lower the rank and order of the member is in the node of the database.

3. The marketing management system as claimed in claim 2, wherein there are three branches are produced from the node.

4. The marketing management system as claimed in claim 1, wherein the cycle calculator further comprises:
an accumulating calculator for calculating the reward of the member in the block in a fixed period;
a first comparator for comparing the reward of the member with a first number limit of the block;
a deduction device for deducting a deduction number of the block from the reward of the member if the reward of the member is larger than the first number limit; and
a dispenser for dispensing the deduction number to a plurality of higher-ranking members at different percentages.

5. The marketing management system as claimed in claim 4, wherein the deduction number of the member is dispensed to three higher-ranking members at different percentages.

6. The marketing management system as claimed in claim 4, wherein the fixed period is a week.

7. The marketing management system as claimed in claim 6, wherein the reward comprises a prize and a bonus, the bonus is the difference between the reward and the deduction number in the block, if the reward is larger than the number limit of the block.

8. The marketing management system as claimed in claim 1, wherein the marketing management system further comprises a promotion calculator comprising:
a promotion comparator for comparing the reward with a promotion number limit of the block; and
an arrangement means for determining a rank and a order of a member in the next block of the database, if the reward of the member in the block is larger than the promotion number limit.

9. The marketing management system as claimed in claim 1, wherein the reward further comprises purchase of different percentages profit from a plurality of lower-ranking member.

10. The marketing management system as claimed in claim 1, further comprising a server system for linking the marketing management system to the Internet.

11. The marketing management system as claimed in claim 1, further comprising a Web server for linking terminals of member to the Internet.

12. A computer-implemented marketing management method utilizing a marketing management system, comprising the steps of:
(a) receiving data from a member and outputting a joining time of the member;
(b) storing the data of member in a database, and determining an order and a rank of a member in a block of the database according to the joining time of the member; and
(c) calculating a reward of the member in the block according to the order and the rank of the member.

13. The method as claimed in claim 12, wherein a plurality of nodes of the database form a tree structure, a plurality of branches are produced from the node, the branch links to a node of the next rank so that the node has a different rank and order with the other nodes, and the later the joining time of the member is, the lower the rank and order of the member is in the node of the database.

14. The method as claimed in claim 13, wherein there are three branches are produced from the node.

15. The method as claimed in claim 12, wherein the step (c) further comprises the steps of:
calculating the reward of the member in the block in a fixed period;
comparing the reward of the member with a first number limit of the block;
deducting a deduction number of the block from the reward of the member if the reward of the member is larger than the first number limit; and
dispensing the deduction number to a plurality of higher-ranking members at different percentages.

16. The method as claimed in claim 15, wherein the deduction number of the member is dispensed to three higher-ranking members at different percentages.

17. The method as claimed in claim 15, wherein the fixed period is a week.

18. The method as claimed in claim 17, wherein the reward comprises a prize and a bonus, the bonus is the difference between the reward and the deduction number in the block, if the reward is larger than the number limit of the block.

19. The method as claimed in claim 12, further comprising the steps of:
comparing the reward with a promotion number limit of the block; and
determining a rank and an order of a member in the next block of the database, if the reward of the member in the block is larger than the promotion number limit.

20. The method as claimed in claim 12, wherein the reward further comprises purchase profit of different percentages from a plurality of lower-ranking members.

21. The method as claimed in claim 12, farther comprising the step of showing a relevant information of the marketing management system on a website.

22. The method as claimed in claim 1, further comprising the step of receiving data from a member on the Internet.

23. A computer-readable medium for recording computer-executable programs for executing a marketing management method, the method comprising the steps of:
(a) receiving data from a member and outputting a joining time of the member;
(b) storing the data of members in a database, and determining an order and a rank of a member in a block of the database according to the joining time of tie member; and
(c) calculating a reward of the member in the block according to the order and the rank of the member.

24. The computer-readable medium as claimed in claim 23, wherein a plurality of nodes of the database form a tree structure, a plurality of branches are produced tom the node, the branch links to a node of the next rank so that the node has different rank and order with the other nodes, and the later the joining time of the member is, the lower the rank and order of the member is in the node of the database.

25. The computer-readable medium as claimed in claim 24, wherein there are three branches are produced from the node.

26. The computer-readable medium as claimed in claim 23, wherein the step (c) further comprises the steps of:
calculating the reward of the member in the block is a fixed period;
comparing the reward of the member with a first number limit of the block;
deducting a deduction number of the block from the reward of the member if the reward of the member is larger than the first number limit; and
dispensing the deduction number to a plurality of higher-ranking members at different percentages.

27. The computer-readable medium as claimed in claim 26, wherein the deduction number of the member is dispensed to three higher-ranking members at different percentages.

28. The computer-readable medium as claimed in claim 26, wherein the fixed period is a week.

29. The computer-readable medium as claimed in claim 28, wherein the reward comprises a prize and a bonus, the bonus is the difference between the reward and the deduction number in the block, if the reward is larger than the number limit of the block.

30. The computer-readable medium as claimed in claim 23, further comprising the steps of:
comparing the reward with a promotion number limit of the block; and
determining a rank and a order of a member in the next block of the database if the reward of the member in the block is larger than the promotion number limit.

31. The computer-readable medium as claimed in claim 23, wherein the reward further comprises purchase profit of different percentages from a plurality of lower-ranking member.

32. The computer-readable medium as claimed in claim 23, further comprising the step of showing a relevant information of the marketing management system on a website.

33. The computer-readable medium as claimed in claim 32, further comprising the step of receiving data from a member on Internet.
